(19) United States
(12) Patent Application Publication
(10) Pub. No.: US 2019/0284936 A1
(43) Pub. Date: Sep. 19, 2019

(54) GAS TURBINE ENGINE ROTOR DISK

(71) Applicant: United Technologies Corporation, Farmington, CT (US)

(72) Inventor: Ryan Hamilton Quinn, Berlin, CT (US)

(21) Appl. No.: 15/921,825

(22) Filed: Mar. 15, 2018

(51) Int. Cl. F01D 5/02; B23C 3/18

(52) U.S. Cl. CPC F01D 5/027; B23C 3/18; F05D 2260/15; F05D 2220/32; F05D 2230/10; B23C 2215/52

(57) ABSTRACT

A rotor disk includes a web that extends in a radial direction from a rim on a radially outer end to a bore on a radially inner end. The web includes a mismatch protrusion on a first axially facing surface of the web. A balancing protrusion is on a second axially facing surface of the web.

### BACKGROUND

A gas turbine engine typically includes a fan section, a compressor section, a combustor section, and a turbine section. Air entering the compressor section is compressed and delivered into the combustion section where it is mixed with fuel and ignited to generate a high-speed exhaust gas flow. The high-speed exhaust gas flow expands through the turbine section to drive the compressor and the fan section.

During operation of the gas turbine engine, the rotating portions of the engine, such as rotor sections in the turbine and compressor sections, are subject to substantial amounts of stress. Therefore, there is a need to reduce the amount of stress the rotating portions experience in order to extend the life of these components.

### SUMMARY

In one exemplary embodiment, a rotor disk includes a web that extends in a radial direction from a rim on a radially outer end to a bore on a radially inner end. The web includes a mismatch protrusion on a first axially facing surface of the web. A balancing protrusion is on a second axially facing surface of the web.

In a further embodiment of any of the above, the mismatch protrusion includes a mismatch plateau that faces in an axial direction and a first mismatch fillet that extends from a radially outer edge of the mismatch plateau to a first mismatch web surface.

In a further embodiment of any of the above, the mismatch protrusion includes a second mismatch fillet that extends from a radially inner edge of the mismatch plateau to a second mismatch web surface.

In a further embodiment of any of the above, the first mismatch web surface and the second mismatch web surface are on a common axial side of the mismatch plateau.

In a further embodiment of any of the above, a radius of the first mismatch fillet and the second mismatch fillet is between 0.230 and 0.270 of an inch.

In a further embodiment of any of the above, the balancing protrusion includes a balancing plateau that faces in an axial direction and a first balancing fillet that extends from a radially outer edge of the balancing plateau to a first balancing web surface.

In a further embodiment of any of the above, the balancing protrusion includes a second balancing fillet that extends from a radially inner edge of the balancing plateau to a second balancing web surface.

In a further embodiment of any of the above, the first balancing web surface and the second balancing web surface are on a common axial side of the balancing plateau.

In a further embodiment of any of the above, the first axially facing surface and the second axially facing surface are directed in opposite axial directions.

In a further embodiment of any of the above, the balancing protrusion is located on a radially outer quarter of the web.

In another exemplary embodiment, a gas turbine engine includes a compressor section and a turbine section that is located downstream of the compressor section. At least one of the compressor section or the turbine section includes a rotor disk that includes a web that extends in a radial direction from a rim on a radially outer end to a bore on a radially inner end. The web includes a mismatch protrusion on a first axially facing surface of the web and a balancing protrusion on a second axially facing surface of the web.

In a further embodiment of any of the above, the mismatch protrusion includes a mismatch plateau facing in an axial direction. A first mismatch fillet extends from a radially outer edge of the mismatch plateau to a first mismatch web surface. A second mismatch fillet extends from a radially inner edge of the mismatch plateau to a second mismatch web surface.

In a further embodiment of any of the above, the first mismatch web surface and the second mismatch web surface are on a common axial side of the mismatch plateau.

In a further embodiment of any of the above, the balancing protrusion includes a balancing plateau that faces in an axial direction. A first balancing fillet extends from a radially outer edge of the balancing plateau to a first balancing web surface. A second balancing fillet extends from a radially inner edge of the balancing plateau to a second balancing web surface.

In a further embodiment of any of the above, the first balancing web surface and the second balancing web surface are on a common axial side of the balancing plateau.

In a further embodiment of any of the above, the first axially facing surface and the second axially facing surface are directed in opposite axial directions.

In one exemplary embodiment, a method of forming rotor disk for a gas turbine engine comprising the steps of machining a first mismatch web surface on a first axial side of the web and machining a second mismatch web surface on the first axial side of the web. A mismatch plateau separates the first mismatch web surface from the second mismatch web surface.

In a further embodiment of any of the above, the method includes forming a balancing protrusion that has a balancing plateau that includes the steps of machining a first balancing web surface on a second axial side of the web and forming a first balancing fillet that extends from a radially outer edge of the balancing plateau. A second balancing web surface on the second axial side of the web is machined. A second balancing fillet that extends from a radially inner edge of the balancing plateau is formed. A balancing plateau separates the first balancing web surface from the second balancing web surface.

In a further embodiment of any of the above, the step of machining the first mismatch web surface includes forming a first mismatch fillet. The step of machining the second mismatch web surface includes forming a second mismatch fillet. The first mismatch web surface and the second mismatch web surface are located on a common axial side of the mismatch plateau.

In a further embodiment of any of the above, the first mismatch fillet and the second mismatch fillet include a radius of 0.230 to 0.280 of an inch.

### BRIEF DESCRIPTION OF THE DRAWINGS

FIG. 1 is a schematic view of an example gas turbine engine according to a first non-limiting example.

FIG. 2 is an enlarged view of an example high pressure turbine section.

FIG. 3 is an enlarged view of an example mismatch protrusion.

FIG. 4 is an enlarged view of an example balancing protrusion.

FIG. 5 is illustrates forming a first portion of the mismatch protrusion of FIGS. 2 and 3.

FIG. 6 illustrates forming a section portion of the mismatch protrusion of FIGS. 2 and 3.

### DETAILED DESCRIPTION

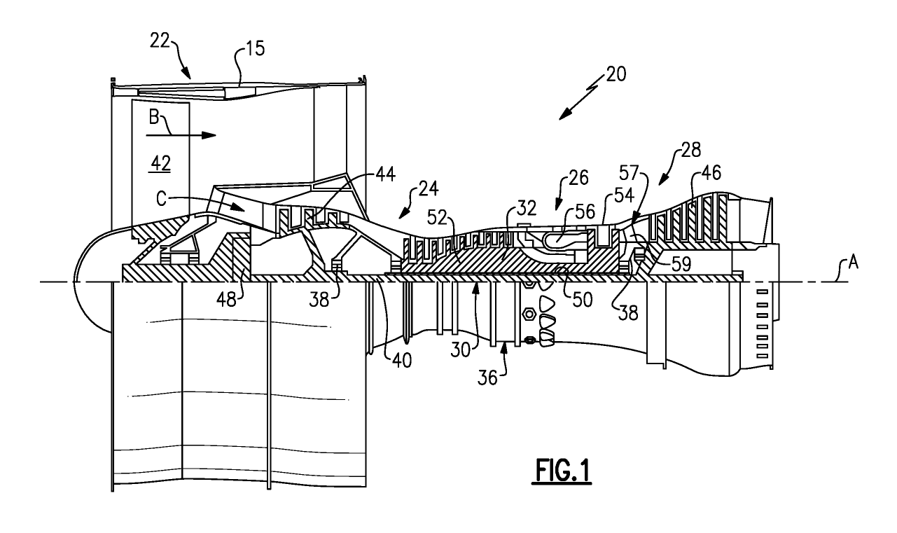

FIG. 1 schematically illustrates a gas turbine engine 20. The gas turbine engine 20 is disclosed herein as a two-spool turbofan that generally incorporates a fan section 22, a compressor section 24, a combustor section 26 and a turbine section 28. The fan section 22 drives air along a bypass flow path B in a bypass duct defined within a nacelle 15, and also drives air along a core flow path C for compression and communication into the combustor section 26 then expansion through the turbine section 28. Although depicted as a two-spool turbofan gas turbine engine in the disclosed non-limiting embodiment, it should be understood that the concepts described herein are not limited to use with two-spool turbofans as the teachings may be applied to other types of turbine engines including three-spool architectures.

The exemplary engine 20 generally includes a low speed spool 30 and a high speed spool 32 mounted for rotation about an engine central longitudinal axis A relative to an engine static structure 36 via several bearing systems 38. It should be understood that various bearing systems 38 at various locations may alternatively or additionally be provided, and the location of bearing systems 38 may be varied as appropriate to the application.

The low speed spool 30 generally includes an inner shaft 40 that interconnects a fan 42, a first (or low) pressure compressor 44 and a first (or low) pressure turbine 46. The inner shaft 40 is connected to the fan 42 through a speed change mechanism, which in exemplary gas turbine engine 20 is illustrated as a geared architecture 48 to drive the fan 42 at a lower speed than the low speed spool 30. The high speed spool 32 includes an outer shaft 50 that interconnects a second (or high) pressure compressor 52 and a second (or high) pressure turbine 54. A combustor 56 is arranged in exemplary gas turbine 20 between the high pressure compressor 52 and the high pressure turbine 54. A mid-turbine frame 57 of the engine static structure 36 is arranged generally between the high pressure turbine 54 and the low pressure turbine 46. The mid-turbine frame 57 further supports bearing systems 38 in the turbine section 28. The inner shaft 40 and the outer shaft 50 are concentric and rotate via bearing systems 38 about the engine central longitudinal axis A which is collinear with their longitudinal axes.

The core airflow is compressed by the low pressure compressor 44 then the high pressure compressor 52, mixed and burned with fuel in the combustor 56, then expanded over the high pressure turbine 54 and low pressure turbine 46. The mid-turbine frame 57 includes airfoils 59 which are in the core airflow path C. The turbines 46, 54 rotationally drive the respective low speed spool 30 and high speed spool 32 in response to the expansion. It will be appreciated that each of the positions of the fan section 22, compressor section 24, combustor section 26, turbine section 28, and fan drive gear system 48 may be varied. For example, gear system 48 may be located aft of combustor section 26 or even aft of turbine section 28, and fan section 22 may be positioned forward or aft of the location of gear system 48.

The engine 20 in one example is a high-bypass geared aircraft engine. In a further example, the engine 20 bypass ratio is greater than about six (6), with an example embodiment being greater than about ten (10), the geared architecture 48 is an epicyclic gear train, such as a planetary gear system or other gear system, with a gear reduction ratio of greater than about 2.3 and the low pressure turbine 46 has a pressure ratio that is greater than about five. In one disclosed embodiment, the engine 20 bypass ratio is greater than about ten (10:1), the fan diameter is significantly larger than that of the low pressure compressor 44, and the low pressure turbine 46 has a pressure ratio that is greater than about five 5:1. Low pressure turbine 46 pressure ratio is pressure measured prior to inlet of low pressure turbine 46 as related to the pressure at the outlet of the low pressure turbine 46 prior to an exhaust nozzle. The geared architecture 48 may be an epicycle gear train, such as a planetary gear system or other gear system, with a gear reduction ratio of greater than about 2.3:1. It should be understood, however, that the above parameters are only exemplary of one embodiment of a geared architecture engine and that the present invention is applicable to other gas turbine engines including direct drive turbofans.

A significant amount of thrust is provided by the bypass flow B due to the high bypass ratio. The fan section 22 of the engine 20 is designed for a particular flight condition—typically cruise at about 0.8 Mach and about 35,000 feet (10,668 meters). The flight condition of 0.8 Mach and 35,000 ft (10,668 meters), with the engine at its best fuel consumption—also known as “bucket cruise Thrust Specific Fuel Consumption (‘TSFC’)”—is the industry standard parameter of lbm of fuel being burned divided by lbf of thrust the engine produces at that minimum point. “Low fan pressure ratio” is the pressure ratio across the fan blade alone, without a Fan Exit Guide Vane (“FEGV”) system. The low fan pressure ratio as disclosed herein according to one non-limiting embodiment is less than about 1.45. “Low corrected fan tip speed” is the actual fan tip speed in ft/sec divided by an industry standard temperature correction of [(Tram ° R)/(518.7° R)]^{0.5}. The “Low corrected fan tip speed” as disclosed herein according to one non-limiting embodiment is less than about 1150 ft/second (350.5 meters/second).

FIG. 2 illustrates an enlarged schematic view of the high pressure turbine 54, however, other sections of the gas turbine engine 20 could benefit from this disclosure, such as the low pressure turbine 46 and the compressor section 24. The high pressure turbine 54 includes a two-stage turbine section with a first rotor assembly 60 and a second rotor assembly 62.

The first rotor assembly 60 includes a first array of rotor blades 64 circumferentially spaced around a first disk 68 and the second rotor assembly 62 includes a second array of rotor blades 66 circumferentially spaced around a second disk 70. Each of the first and second array of rotor blades 64, 66 include a respective first root portion 72 and a second root portion 74, a first platform 76 and a second platform 78, and a first airfoil 80 and a second airfoil 82. Each of the first and second root portions 72, 74 is received within a respective first rim and a second rim 84, 86 of the first and second disk 68, 70. The first airfoil 80 and the second airfoil 82 extend radially outward toward a first and second blade outer air seal (BOAS) assembly 81, 83, respectively.

The first and second array of rotor blades 64, 66 are disposed in the core flow path C that is pressurized in the compressor section 24 then heated to a working temperature in the combustor section 26. The first and second platforms 76, 78 separate a gas path side inclusive of the first and second airfoils 80, 82 and a non-gas path side inclusive of the first and second root portions 72, 74.

A shroud assembly 88 within the engine case structure 36 between the first rotor assembly 60 and the second rotor assembly 62 directs the hot gas core airflow in the core flow path from the first array of rotor blades 64 to the second array of rotor blades 66. The shroud assembly 88 includes an array of vanes 90 that each include at least two airfoils 91 that extend between a respective inner vane platform 92 and an outer vane platform 94. The outer vane platform 94 of the vane 90 may at least partially engage the first and second BOAS 81, 83.

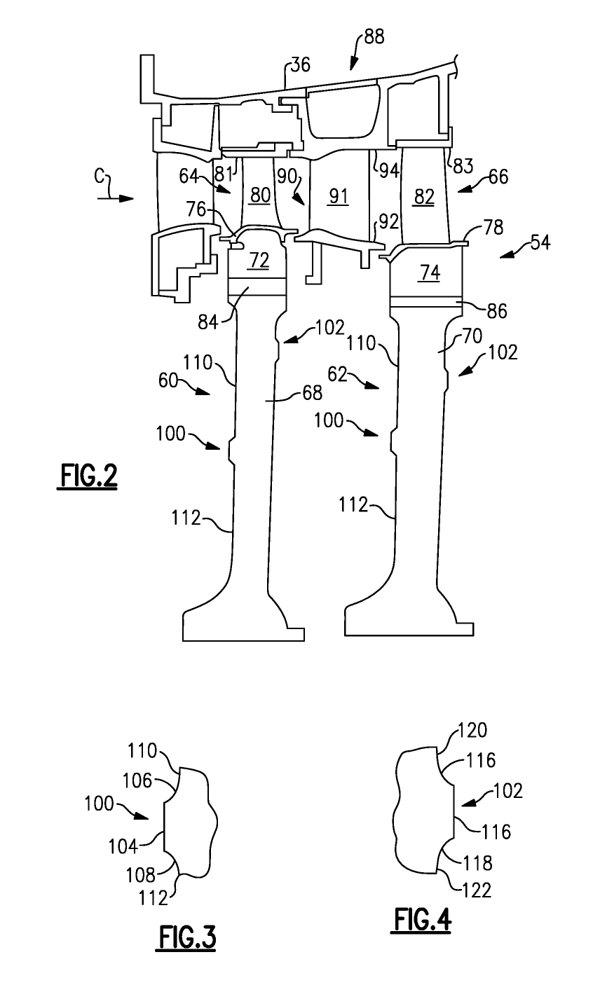

As shown in FIGS. 2-4, the first disk 68 and the second disk 70 each include a mismatch protrusion 100 and a balancing protrusion 102. In the illustrated non- limiting example, the mismatch protrusion 100 is located on an axially forward facing side of the first and second disks 68, 70 and the balancing protrusion is located on an axially aft facing side of the first and second disks 68, 70.

The mismatch protrusion 100 includes a mismatch plateau 104 defined by a radially outer fillet 106 and a radially inner fillet 108. The radially outer fillet 106 transitions from the mismatch plateau 104 to a first mismatch web surface 110 located radially outward from the mismatch protrusion 100. The radially inner fillet 108 transitions form the mismatch plateau 104 to a second mismatch web surface 112 located radially inward from the mismatch protrusion 100. The radially inner and outer fillets 108, 106 include a radius of between 0.230 and 0.270 thousandths of an inch (5.842 and 6.858 mm).

The first and second mismatch web surfaces 110 and 112 are located on a common axial side of the mismatch plateau 104, such that the first and second mismatch web surfaces 110, 112 are either forward or aft of the mismatch plateau 104. Moreover, the first and second mismatch web surfaces 110, 112 adjacent the outer and inner fillets 106, 108, respectively, are equidistant from the mismatch plateau 104. The location of the first and second mismatch web surfaces 110, 112 relative to the mismatch plateau 104 reduces the stress concentration at the intersection of the outer and inner fillets 106, 108 and the mismatch plateau 104. In the illustrated example, the mismatch protrusion 100 is located in the radially inner half of the first and second disks 68, 70.

Without having the mismatch plateau 104, only a single fillet would exist between the first and second mismatch web surfaces 110, 112, which would result in a higher stress concentration. Furthermore, prior attempts to match the first and second mismatch web surfaces 110, 112 resulted in even high stress concentrations because the fillet the between the two machined web surface is on the order of one tenth the size of the radius of the inner and outer fillets 108, 106.

The balancing protrusion 102 includes a balancing plateau 114 defined by a radially outer fillet 116 and a radially inner fillet 118. The radially outer fillet 116 transitions from the balancing plateau 114 to a first balancing web surface 120 located radially outward from the balancing protrusion 102. The radially inner fillet 118 transitions form the balancing plateau 114 to a second balancing web surface 122 located radially inward from the balancing protrusion 102. The first and second balancing web surfaces 120 and 122 are located on a common axial side of the balancing plateau 114, such that the first and second balancing web surfaces 120, 122 are either forward or aft of the balancing plateau 114.

In the illustrated example, the balancing protrusion 102 is located in a radially outer quarter of the first and second disks 68, 70. The balancing protrusion 102 is located radially outward of the mismatch protrusion 100 because the balancing protrusion 102 has a greater influence and balancing one of the first and second rotor disks 68, 70 the further it is located from the axis of rotation A.

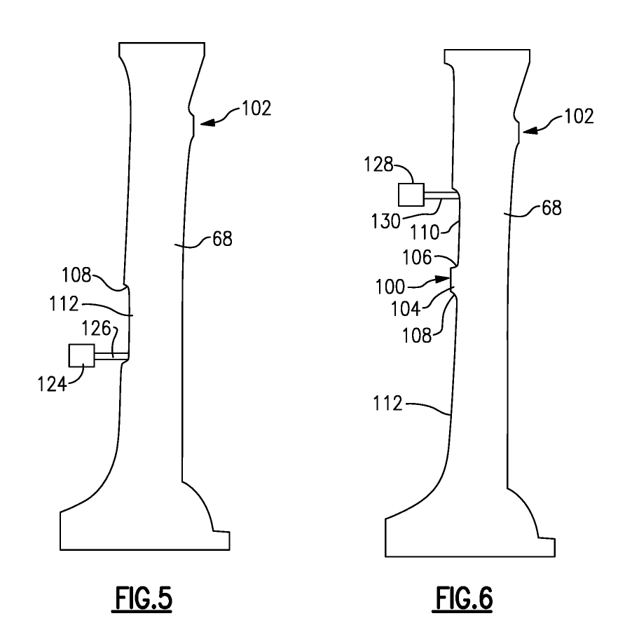

As shown in FIGS. 5 and 6, the mismatch protrusion 100 is formed through machining A tool 124 having a bit 126 engages the first disk 68 to form the radially inner fillet 118 and the second mismatch web surface 112 as shown in FIG. 5. Due to the geometry of the first disk 68, a different tool 128 and/or a different bit 130 might be needed to form the radially outer fillet 116 and the first mismatch web surface 110 as shown in FIG. 6. The mismatch plateau 104 functions as an indexing location on the first disk 68 such that when the first and second mismatch web surfaces 110, 112. The mismatch protrusion 100 on the second disk 70 is formed in a similar manner

The preceding description is exemplary rather than limiting in nature. Variations and modifications to the disclosed examples may become apparent to those skilled in the art that do not necessarily depart from the essence of this disclosure. The scope of legal protection given to this disclosure can only be determined by studying the following claims.

What is claimed is:

1. A rotor disk comprising:
a web extending in a radial direction from a rim on a radially outer end to a bore on a radially inner end, the web including:
a mismatch protrusion on a first axially facing surface of the web; and
a balancing protrusion on a second axially facing surface of the web.

2. The rotor disk of claim 1, wherein the mismatch protrusion includes a mismatch plateau facing in an axial direction and a first mismatch fillet extending from a radially outer edge of the mismatch plateau to a first mismatch web surface.

3. The rotor disk of claim 2, wherein the mismatch protrusion includes a second mismatch fillet extending from a radially inner edge of the mismatch plateau to a second mismatch web surface.

4. The rotor disk of claim 3, wherein the first mismatch web surface and the second mismatch web surface are on a common axial side of the mismatch plateau.

5. The rotor disk of claim 3, wherein a radius of the first mismatch fillet and the second mismatch fillet is between 0.230 and 0.270 of an inch.

6. The rotor disk of claim 3, wherein the balancing protrusion includes a balancing plateau facing in an axial direction and a first balancing fillet extending from a radially outer edge of the balancing plateau to a first balancing web surface.

7. The rotor disk of claim 6, wherein the balancing protrusion includes a second balancing fillet extending from a radially inner edge of the balancing plateau to a second balancing web surface.

8. The rotor disk of claim 7, wherein the first balancing web surface and the second balancing web surface are on a common axial side of the balancing plateau.

9. The rotor disk of claim 1, wherein the first axially facing surface and the second axially facing surface are directed in opposite axial directions.

10. The rotor disk of claim 1, wherein the balancing protrusion is located on a radially outer quarter of the web.

11. A gas turbine engine comprising:
a compressor section; and
a turbine section located downstream of the compressor section, wherein at least one of the compressor section or the turbine section includes a rotor disk including:
a web extending in a radial direction from a rim on a radially outer end to a bore on a radially inner end, the web including:
a mismatch protrusion on a first axially facing surface of the web; and
a balancing protrusion on a second axially facing surface of the web.

12. The gas turbine engine of claim 11, wherein the mismatch protrusion includes a mismatch plateau facing in an axial direction, a first mismatch fillet extending from a radially outer edge of the mismatch plateau to a first mismatch web surface, and a second mismatch fillet extending from a radially inner edge of the mismatch plateau to a second mismatch web surface.

13. The gas turbine engine of claim 12, wherein the first mismatch web surface and the second mismatch web surface are on a common axial side of the mismatch plateau.

14. The gas turbine engine of claim 12, wherein the balancing protrusion includes a balancing plateau facing in an axial direction, a first balancing fillet extending from a radially outer edge of the balancing plateau to a first balancing web surface, and a second balancing fillet extending from a radially inner edge of the balancing plateau to a second balancing web surface.

15. The gas turbine engine of claim 14, wherein the first balancing web surface and the second balancing web surface are on a common axial side of the balancing plateau.

16. The gas turbine engine of claim 11, wherein the first axially facing surface and the second axially facing surface are directed in opposite axial directions.

17. A method of forming rotor disk for a gas turbine engine comprising the steps of:
machining a first mismatch web surface on a first axial side of the web; and
machining a second mismatch web surface on the first axial side of the web, wherein a mismatch plateau separates the first mismatch web surface from the second mismatch web surface.

18. The method of claim 17, further comprising forming a balancing protrusion having a balancing plateau including the steps of:
machining a first balancing web surface on a second axial side of the web and forming a first balancing fillet extending from a radially outer edge of the balancing plateau; and
machining a second balancing web surface on the second axial side of the web and forming a second balancing fillet extending from a radially inner edge of the balancing plateau, wherein a balancing plateau separates the first balancing web surface from the second balancing web surface.

19. The method of claim 17, wherein the step of machining the first mismatch web surface including forming a first mismatch fillet and the step of machining the second mismatch web surface includes forming a second mismatch fillet and the first mismatch web surface and the second mismatch web surface are located on a common axial side of the mismatch plateau.

20. The method of claim 19, wherein the first mismatch fillet and the second mismatch fillet include a radius of 0.230 to 0.280 of an inch.
